(19) United States
(12) Patent Application Publication
(10) Pub. No.: US 2024/0305024 A1
(43) Pub. Date: Sep. 12, 2024

(54) ELECTRICAL CONNECTOR CONTACT ASSEMBLY HAVING UPPER AND LOWER GROUND PLATES SURROUNDING A ROW OF CONTACTS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: PATRICK R. CASHER, North Aurora, IL (US); Terrance F. LITTLE, Fullerton, CA (US); Chun-Hsiung HSU, New Taipei (TW); Yi-Min HSU, New Taipei (TW); Haozhe ZI, Irvine, CA (US)

(21) Appl. No.: 18/603,130

(22) Filed: Mar. 12, 2024

Related U.S. Application Data
(60) Provisional application No. 63/489,773, filed on Mar. 12, 2023.

(51) Int. Cl. H01R 12/71; H01R 13/6471; H01R 13/6474

(52) U.S. Cl. CPC H01R 12/716; H01R 13/6471; H01R 13/6474

(57) ABSTRACT

A contact assembly for an electrical connector including: a row of contacts having plural contacting portions and plural mounting portions; an insulator secured to the plural contacting portions and the plural mounting portions; and an upper ground plate and a lower ground plate surrounding the row of contacts, wherein a conductive element is provided to electrically connect the upper and lower ground plates and selected ones of the row of contacts, or at least one of the upper and lower ground plates integrally forms plural ground sections constituting part of the plural contacting portions of the row of contacts.

### CROSS REFERENCE TO RELATED APPLICATION

This application claims priority to and benefit of U.S. Provisional Patent Application No. 63/489,773, filedMar. 12, 2023.

### BACKGROUND OF THE INVENTION

### Field of the Invention

The present invention relates to a contact assembly for an electrical connector, comprising a row of contacts having a plurality of contacting portions and a plurality of mounting portions, an insulator secured to the plurality of contacting portions and the plurality of mounting portions, an upper ground plate and a lower ground plate surrounding the row of contacts, and a conductive element electrically connecting the upper and lower ground plates.

### Description of Related Arts

U.S. Patent Application Publication No. 2021/0328384 discloses a conductive ground shield which may be plural split-shields or a single piece. Also disclosed is combining the conductive ground shield and metal ground conductors, as seen in drawing FIG. 3L thereof.

U.S. Patent Application Publication No. 2022/0352675 discloses a lead frame assembly having corrugated sheet or sheets. The corrugated sheets may be provided on a top surface, a bottom surface, or both the top and bottom surfaces of the lead frame assembly. The corrugated sheet electrically couples ground conductors and may be made of material that is electrically conductive or lossy. Electrically lossy materials typically have a bulk conductivity of about 1 to 100,000 Siemen/meter.

### SUMMARY OF THE INVENTION

A contact assembly for an electrical connector comprises: a row of contacts having a plurality of contacting portions and a plurality of mounting portions; an insulator secured to the plurality of contacting portions and the plurality of mounting portions; an upper ground plate and a lower ground plate surrounding the row of contacts; and a conductive element electrically connecting the upper and lower ground plates and selected ones of the row of contacts.

A contact assembly for an electrical connector comprises: a row of contacts having a plurality of contacting portions and a plurality of mounting portions; an insulator secured to the plurality of contacting portions and the plurality of mounting portions; and an upper ground plate and a lower ground plate surrounding the row of contacts, wherein at least one of the upper and lower ground plates integrally forms a plurality of ground sections constituting part of the plurality of contacting portions of the row of contacts.

An electrical connector for mounting on a circuit board and mating with a mating connector comprises a contact assembly, the contact assembly comprising: a row of contacts having a plurality of contacting portions for differential pair signals and a plurality of mounting portions for differential pair signals; an upper ground plate and a lower ground plate surrounding the row of contacts, wherein at least one of the upper and lower ground plates integrally forms a plurality of ground sections aligning with the contacting portions for differential pair signals, and at least one of the upper and lower ground plates integrally forms a plurality of ground sections aligning with the mounting portions for differential pair signals.

### BRIEF DESCRIPTION OF DRAWINGS

FIG. 1 is a perspective view of an electrical connector incorporating a contact assembly in accordance with the present invention;

FIG. 2 is a view similar to FIG. 1 but from another perspective;

FIG. 3 is a front view of the electrical connector;

FIG. 4 is a rear view of the electrical connector;

FIG. 5 is another rear perspective view of the electrical connector;

FIG. 6 is a cross-sectional view of the electrical connector taken along line A-A in FIG. 1;

FIG. 7 is a cross-sectional view of the electrical connector taken along line B-B in FIG. 1;

FIG. 8 is a cross-sectional view of the electrical connector taken along line C-C in FIG. 1;

FIG. 9 is an exploded view of the electrical connector;

FIG. 10 is a view similar to FIG. 9 but from another perspective;

FIG. 11 is a further exploded view of FIG. 9;

FIG. 12 is a view similar to FIG. 10 but from another perspective;

FIG. 13 is an enlarged exploded view of a part of the electrical connector in FIG. 9;

FIG. 14 is a view similar to FIG. 13 but from another perspective; FIG. 15 is an enlarged view of another part of the electrical connector in FIG. 9;

FIG. 16 is a view similar to FIG. 15 but omitting certain elements;

FIG. 17 is an exploded view of FIG. 16 omitting certain elements;

FIG. 18 is a side view of FIG. 17;

FIG. 19 is a perspective view of the contact assembly;

FIG. 20 is a view similar to FIG. 19 but from another perspective;

FIG. 21 is an exploded view of the contact assembly;

FIG. 22 is a view similar to FIG. 19 but omitting certain elements;

FIG. 23 is an exploded view of another contact assembly;

FIG. 24 is a view similar to FIG. 23 but omitting certain elements;

FIG. 25 is a side view of a varied contact assembly in accordance with the present invention;

FIG. 26 shows a blank material of an upper ground plate of the varied contact assembly;

FIG. 27 is a perspective view of the upper ground plate after it is formed into shape;

FIG. 28 is a view similar to FIG. 27 but from another perspective;

FIG. 29 is a view similar to FIG. 27 but showing a lower ground plate of the varied contact assembly;

FIG. 30 is a perspective view of the varied contact assembly; and

FIG. 31 is a side view of varied upper and lower contact assemblies.

### DETAILED DESCRIPTION OF THE DRAWINGS

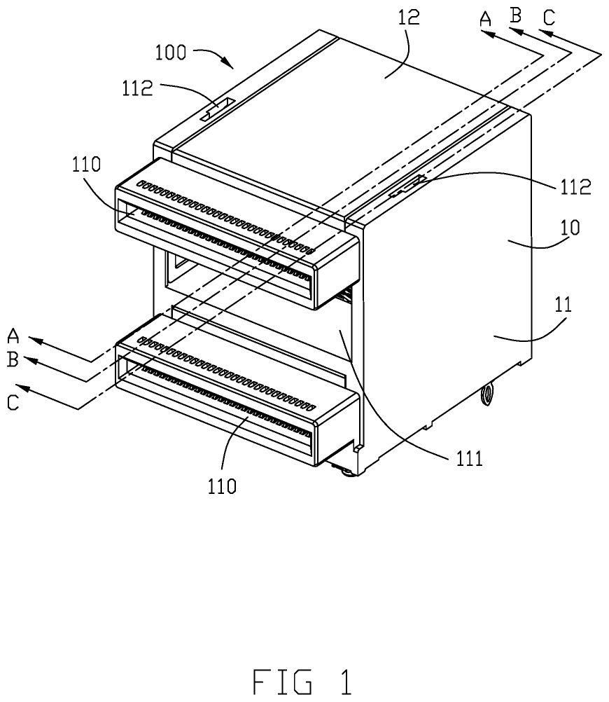

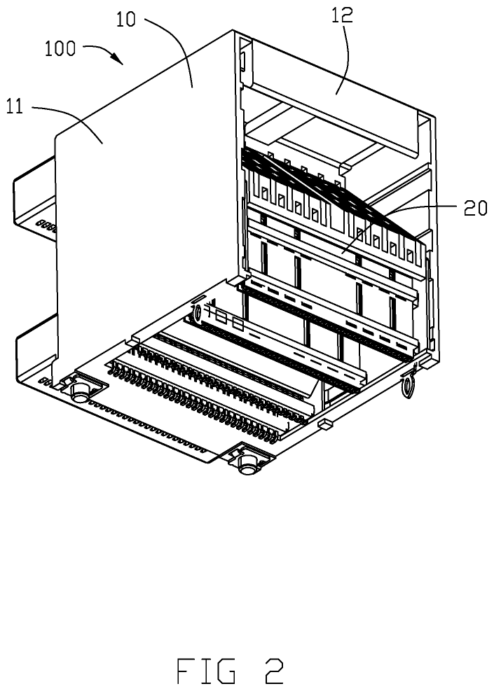

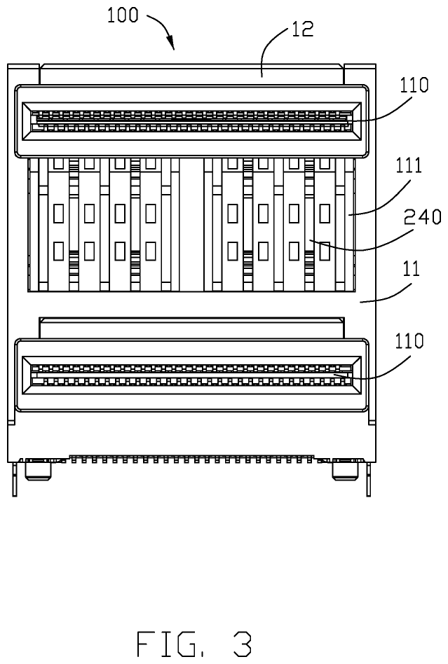

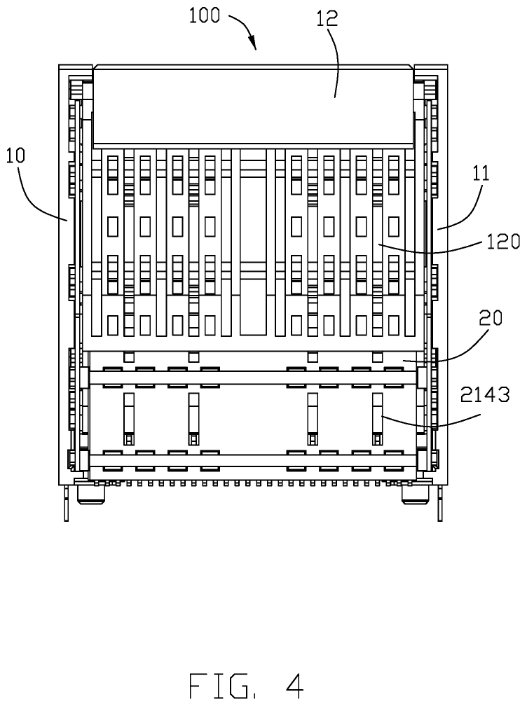

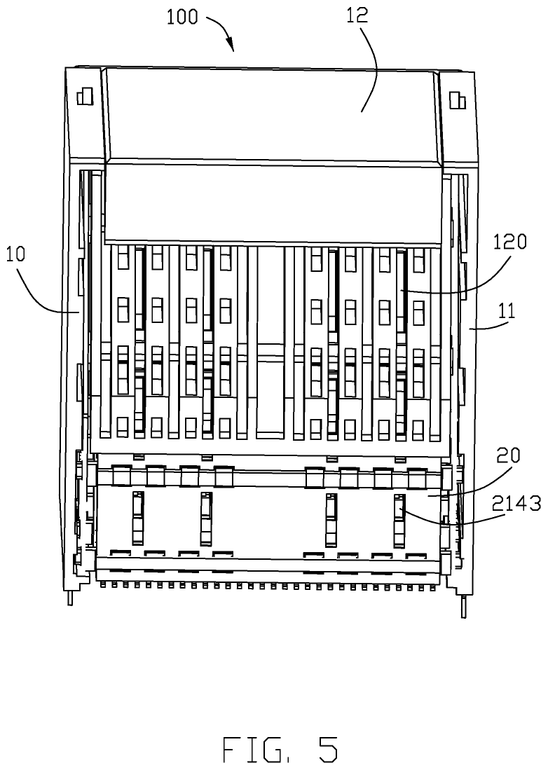

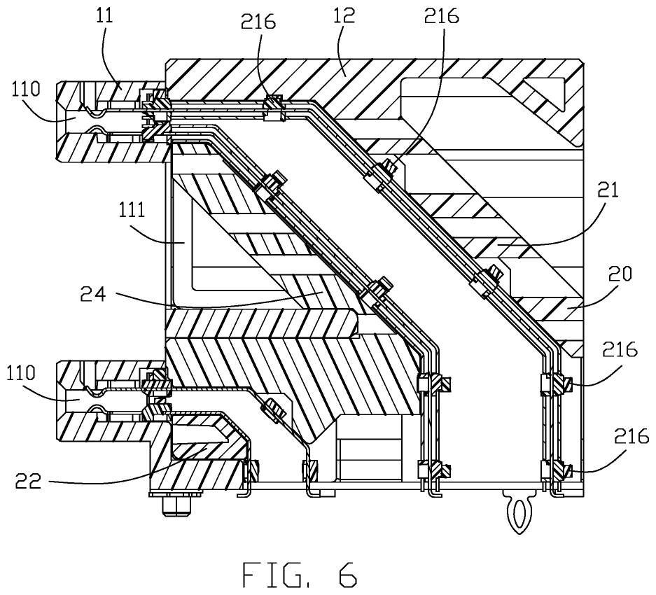

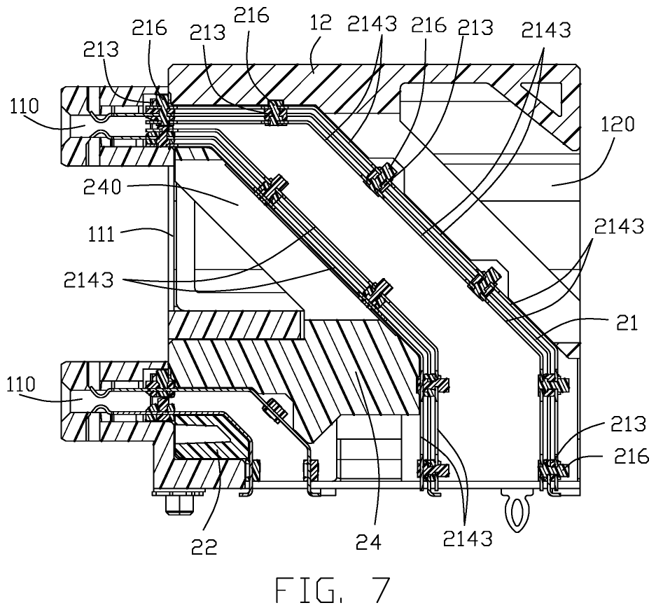

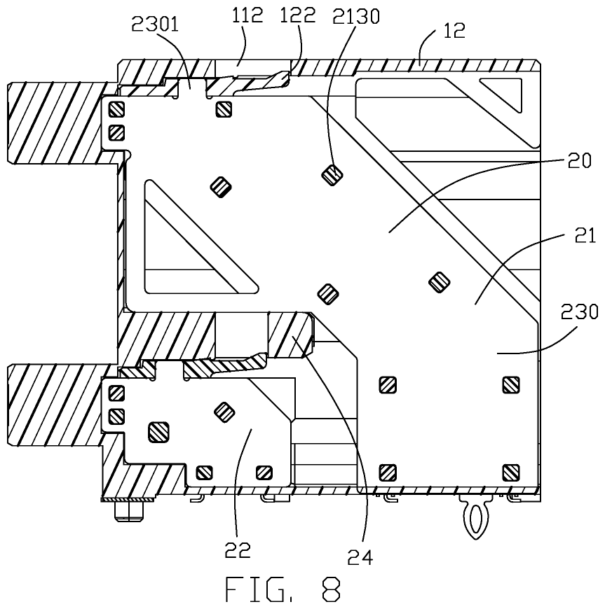

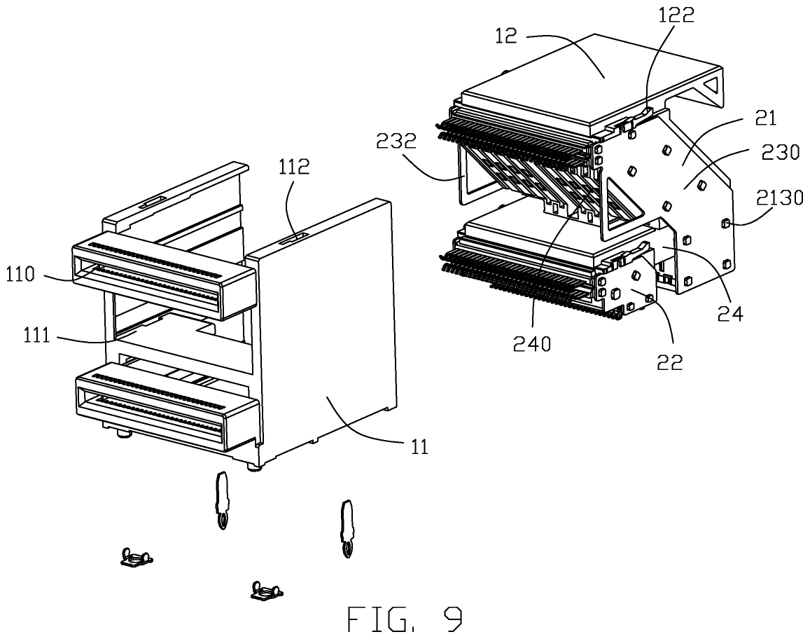

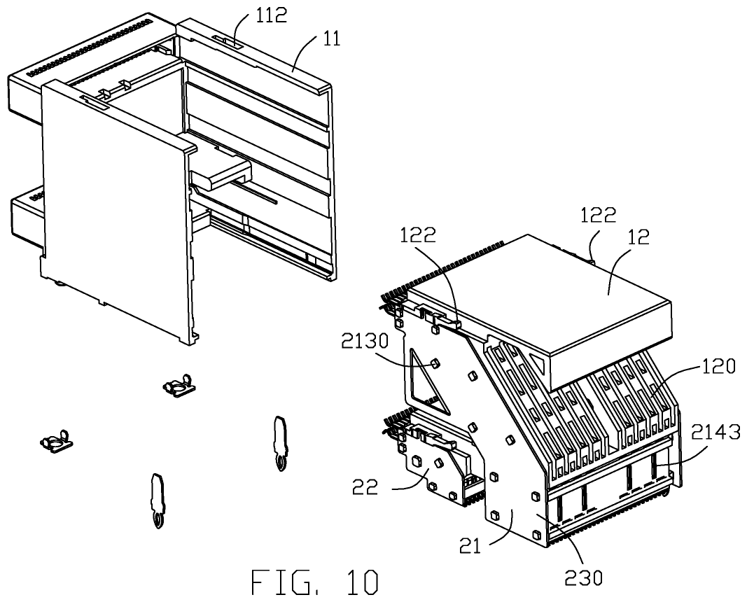

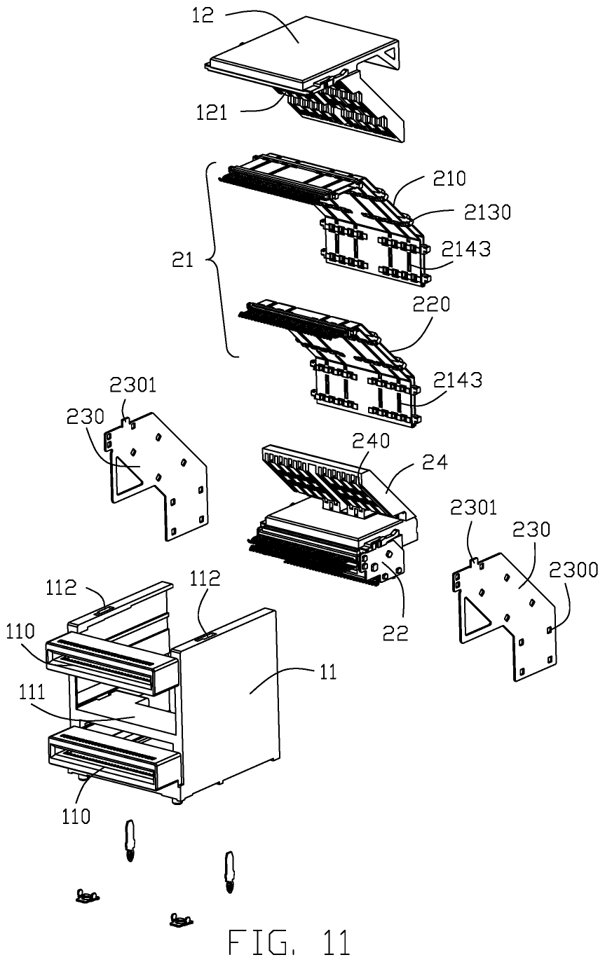

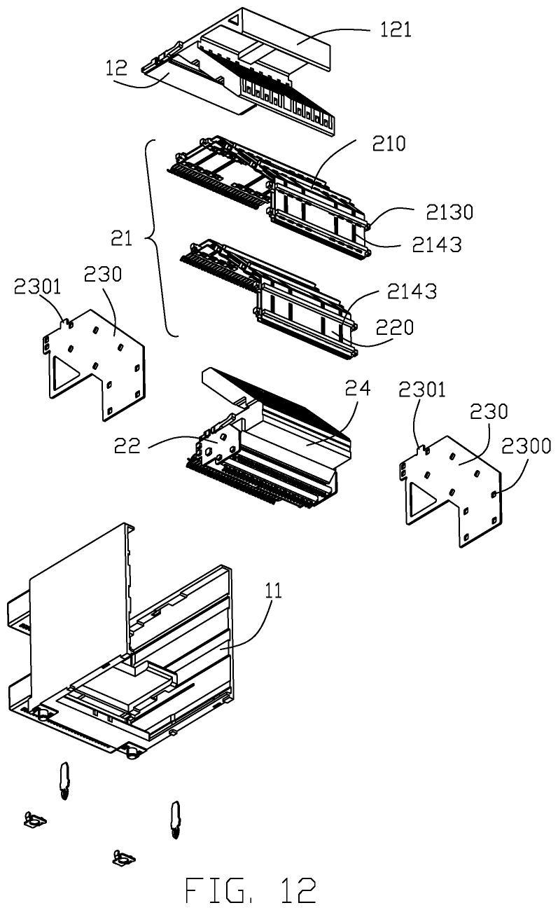

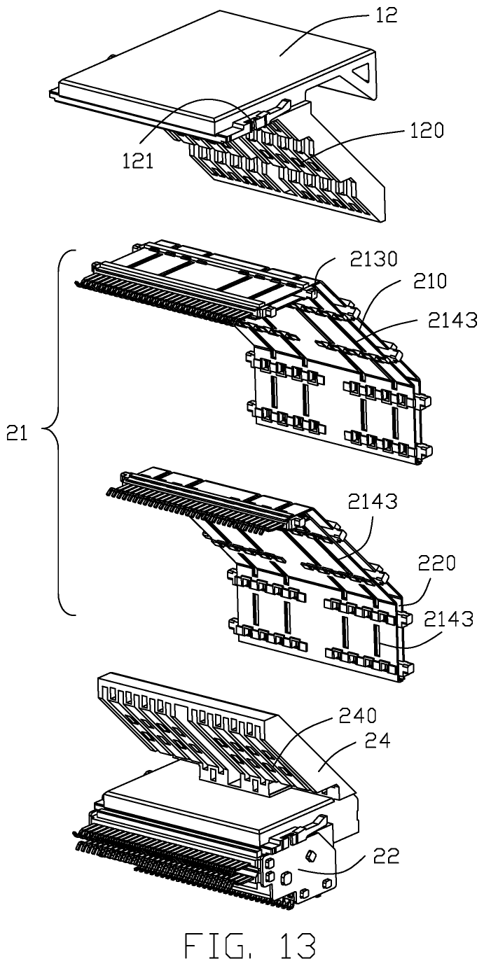

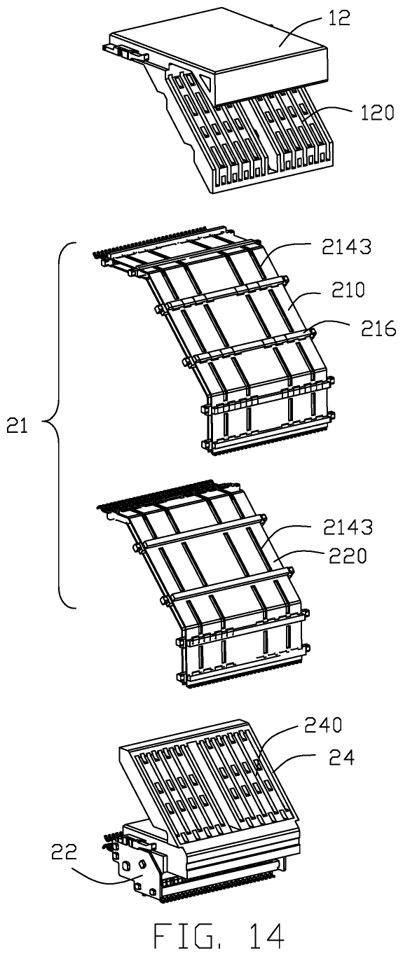

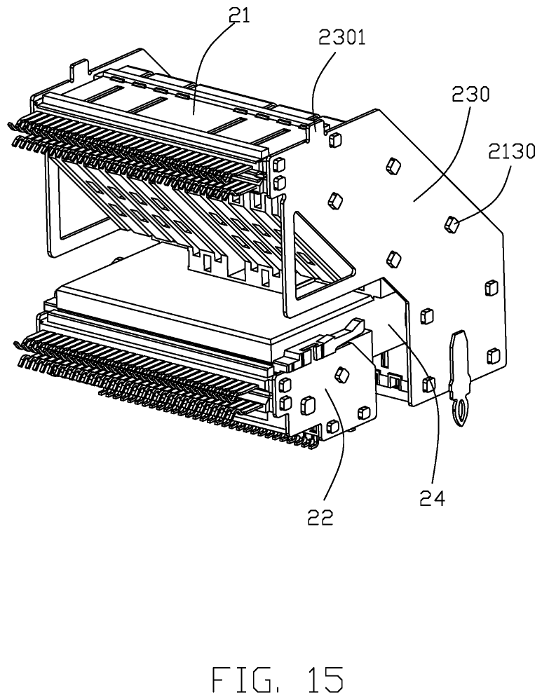

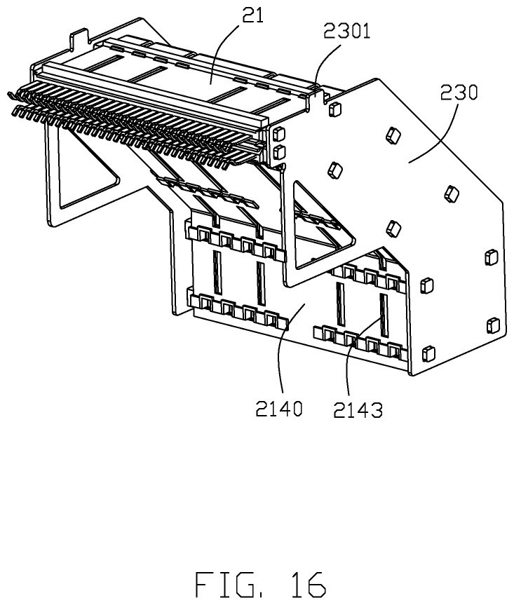

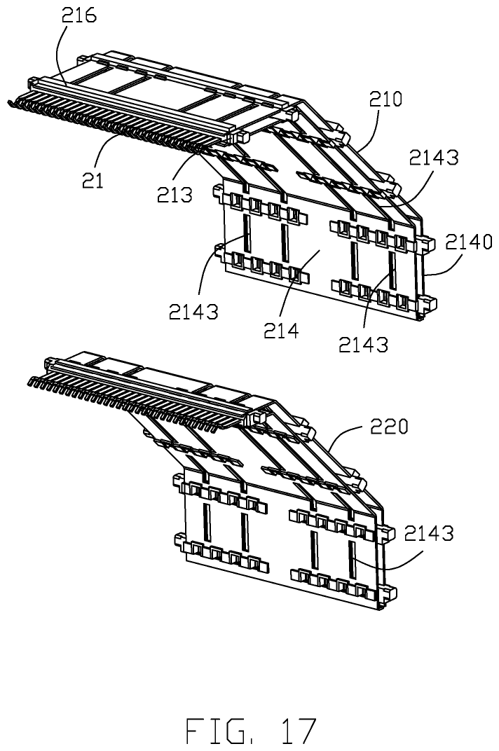

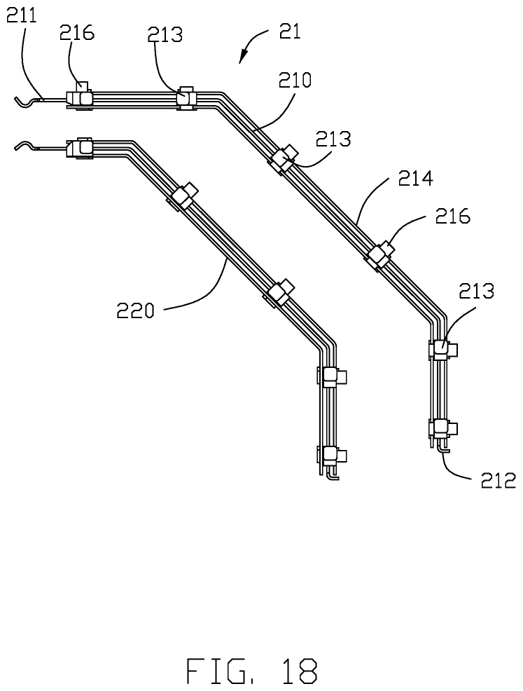

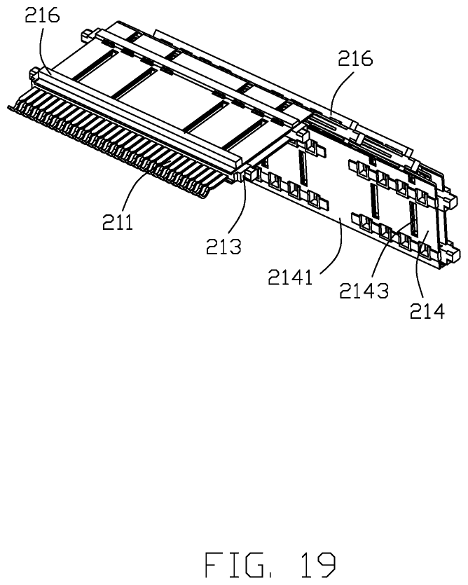

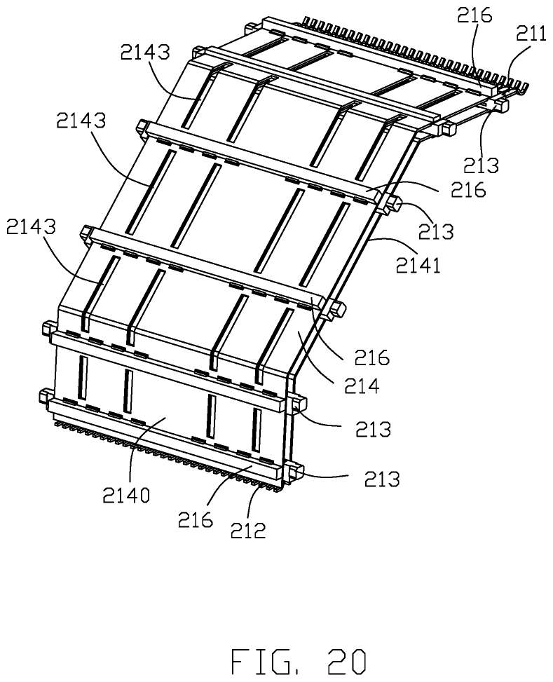

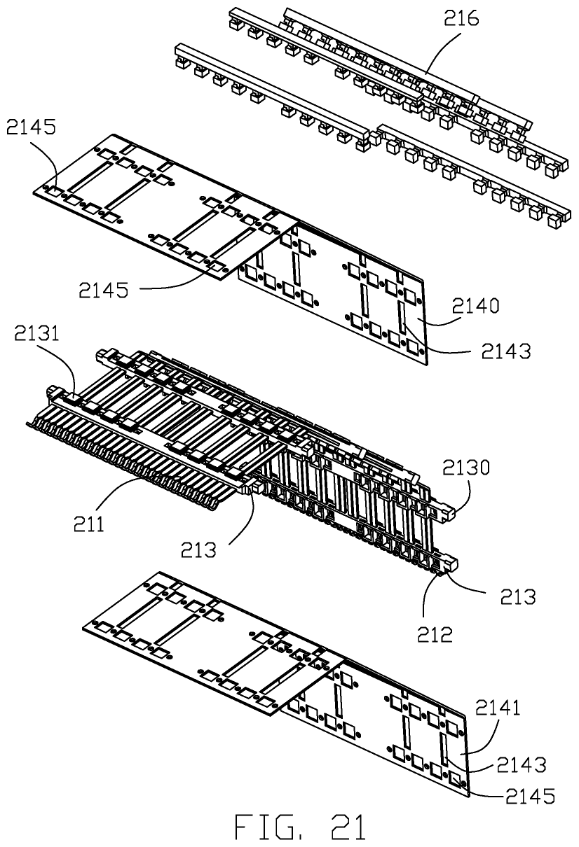

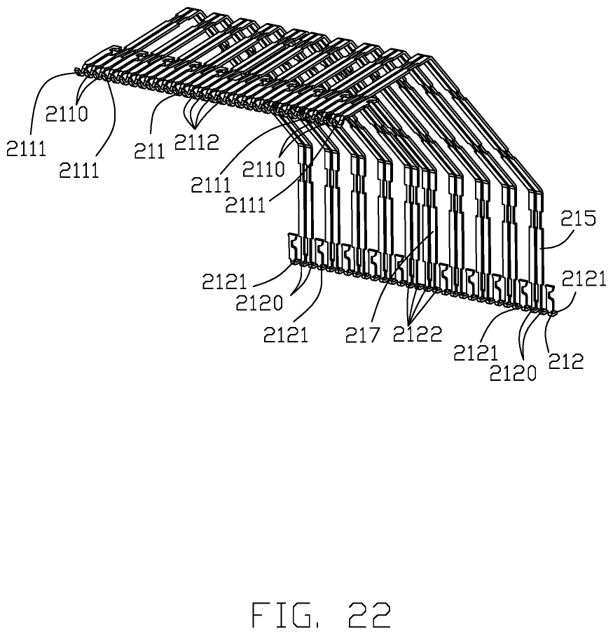

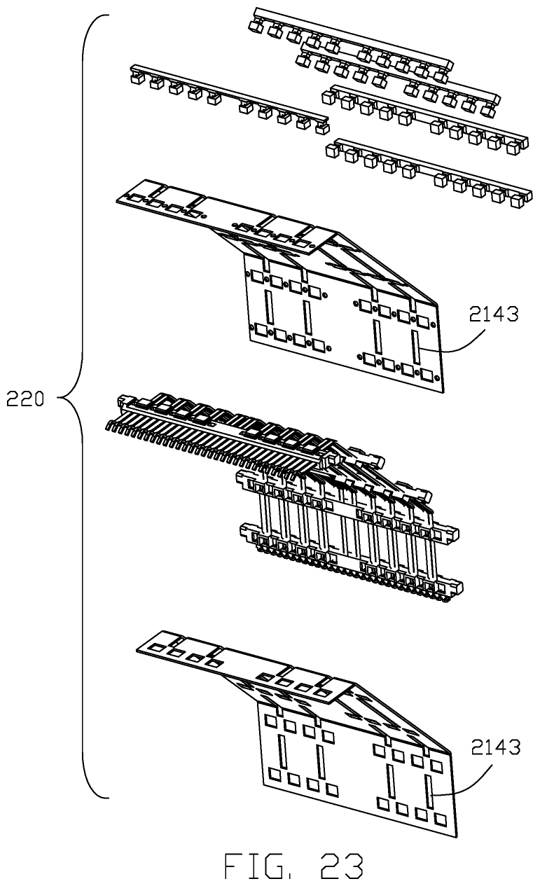

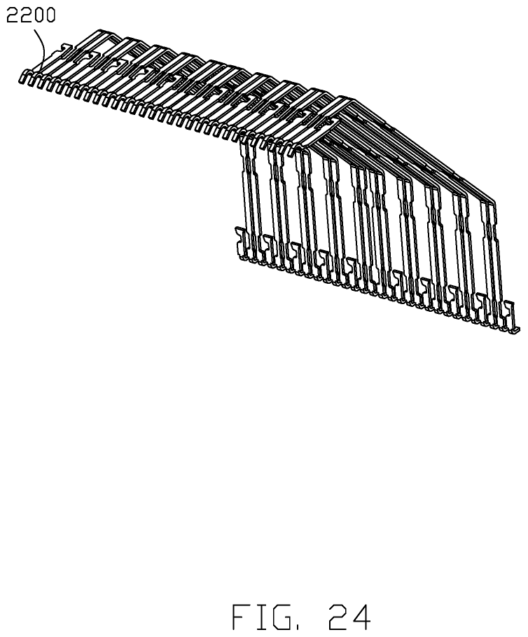

Referring to FIGS. 1-24, an electrical connector 100 comprises an insulative housing 10 and a contact module 20 in the insulative housing 10. The insulative housing 10 includes a main body 11 and a cover 12. The main body 11 has upper and lower mating ports 110 and an intermediate opening 111 therebetween. The insulating housing 10 can also be a suitable structure with more or less parts, and the mating ports 110 can also be designed to have fewer or more The cover 12 has plural grooves 120, a pair of slots 121, and a pair of latching arms 122. The main body 11 has corresponding latching holes 112.

The contact module 20 in the embodiment shown includes an upper unit 21, a lower unit 22, and a separator 24 therebetween. The upper unit 21 includes an upper assembly 210, a lower assembly 220, and a pair of side plates 230 for assembling the upper and lower assemblies 210 and 220. The upper assembly 210 and the lower assembly 220 together form a mating area and are electrically connected to two opposite surfaces of the mating connector The separator 24 has plural openings 240 for circulation of air. The side plate 230 has a protrusion 2301 for engaging a corresponding slot 121 so as to combine the upper and lower assemblies 210 and 220 and the cover 12 together. The lower unit 22 may be similarly structured.

The upper assembly 210 includes a row of contacts having a plurality of contacting portions 211 and a plurality of mounting portions 212 and intermediate portions 215 connected therebetween, an insulator 213 secured to the contacting portions 211 and the mounting portions 212, a ground structure 214 having an upper ground plate 2140 and a lower ground plate 2141 that surround the row of contacts, and a conductive element 216 electrically connecting the upper and lower ground plates 2140 and 2141 and selected ones of the row of contacts. The plurality of contacting portions 211 may include those sections 2110 for differential pair signals and those sections 2111 for grounds; the plurality of mounting portions 212 similarly include sections 2120 for differential pair signals and those sections 2121 for grounds. The ground sections 2111 and 2121 are electrically connected by the ground structure 214 and the conductive element 216. The plurality of contacting portions 211 may also include those side-band sections 2112 for control, power, and low-speed signals and the plurality of mounting portions 212 similarly include corresponding sections 2122, with associated intermediate portions 217 connected therebetween. The conductive element 216 is disposed on the insulator 213 to electrically connect the ground structure 214 and the ground sections 2111 and the ground sections 2121. Those ground sections 2111 and those ground sections 2121 are electrically connected through the ground structure 214 , that is, Those ground sections 2111 and those ground sections 2121 are connected to a common ground The insulator 213 has plural protruding blocks 2131 and the ground structure 214 has mounting holes 2145. The protruding blocks 2131 cooperate with the mounting holes 2145 to install the ground structure 214 to the upper assembly 210. In this embodiment, there are eight high-speed signal channels in the upper assembly 210, which are divided into two groups and are arranged on two sides. Other signal channels such as low-speed signals, power supply, control, etc., are set in the middle of the two sides. Of course, the number of high-speed signal channels can be any number greater than or equal to one. The number of low-speed signals, power supply, control, and other signal channels can also be increased or decreased, or even not provided.

The upper ground plate 2140 and the lower ground plate 2141 surround signal contacts of the row of contacts to form a strip-line structure for achieving a better high speed transmission performance, like a PCB style design.

The conductive element 216 may be separately made and then mounted to the insulator 23 or formed in situ, e.g., molded from conductive plastic material having a surface resistivity of about 0.1 Ω/square or having a bulk resistivity of about 0.01 Ω-cm. Of course, conductive plastic materials with surface resistivity greater than 0.1 Ω/square can also be used, or conductive plastic materials with bulk resistivity greater than 0.02 Ω-cm can be used. When using molded conductive element 216, after the ground structure 214 and the insulator 213 are assembled, the conductive element 216 is molded to electrically connect the ground sections 2111 or the ground sections 2121 to the ground structure 214. The conductive element 216 can also be molded on the insulator 213 first, and electrically connected to the ground sections 2111 or the ground sections 2121, and then the ground structure 214 may be assembled so that the ground structure 214 and the conductive element 216 are electrically connected. When using separately made and mounted conductive element 216, after the ground structure 214 and the insulator 213 are assembled, the conductive element 216 is assembled to electrically connect the ground sections 2111 or the ground sections 2121 to the ground structure 214. The conductive element 216 and the insulator 213 may also be assembled first, and electrically connected to the ground sections 2111 or the ground sections 2121, and then assemble the ground structure 214 and the conductive element 216 to be electrically connected, thereby achieving electrical connection with the ground sections 2111 and the ground sections 2121.

Each of the upper and lower ground plates 2140 and 2141 is sheet metal plates, and are formed by bending according to the overall extended shape of the entire upper assembly 210. The upper and lower ground plates 2140 and 2141 can be a single metal plate or a multi-piece metal plate. The upper and lower ground plates 2140 and 2141 are electrically connected to all the ground sections 2111 and ground sections 2121. Of course, the upper ground plates 2140 is electrically connected to part of the ground sections 2111 and the ground sections 2121, and the lower ground plates 2141 is electrically connected to the remaining ground sections 2111 and ground sections 2121.

To have a better shielding effect, the ground structure 214 may span a width beyond outermost contacting portions 211 and outermost mounting portions 212. The upper and lower ground plates 2140 and 2141 are spaced apart from the intermediate portions 215 and the intermediate portions 217 through the insulator 213. Therefore, the intermediate portions 215 and the intermediate portions 217 are exposed to the air except for the parts formed on the insulator 213. Neither the upper ground plates 2140 nor the lower ground plates 2141 is electrically connected to the intermediate portions 215 and the intermediate portions 217. The upper ground plate 2140 is disposed on one side of the row of contacts and spaced a first distance away from the intermediate portions 215, and the lower ground plate 2141 is disposed on the other side of the row of contacts and spaced a second distance away from the intermediate portions 215. The first distance is equal to the second distance. The conductive element 216 electrically connects the ground sections 2111, the upper ground plate 2140 and the lower ground plate 2141 together. The conductive element 216 electrically connects the ground sections 2121, the upper ground plate 2140 and the lower ground plate 2141 together. Each of the upper and lower ground plates 2140 and 2141 has plural openings 2143 for circulation of air for cooling purpose. The openings 2143 are elongated, therefore, airflow can circulate through the openings 2143 on the upper ground plate 2140, the space between the upper ground plate 2140 and the lower ground plate 2141, and the openings 2143 on the lower ground plate 2141. thereby forming an air heat dissipation channel. The grooves 120 on the cover 12 and the openings 2143 on the upper ground plate 2140, the space between the upper ground plate 2140 and the lower ground plate 2141, the openings 2143 on the lower ground plate 2141, the space between the upper assembly 210 and the lower assembly 220, the openings 2143 on the lower assembly 220 that is the same as that on the upper assembly 210, the openings 240 of the separator 24 and the intermediate opening 111 on the main body 11 are in air communication. Therefore, the electrical connector 100 has an air heat dissipation channel as a whole.

In other embodiments, The ground sections 2111 can be directly punched and formed through the ground structure 214. The ground sections 2111 can be formed by punching from one of the upper ground plate 2140 and the lower ground plate 2141, or they can be formed by the upper ground plate 2140 and the lower ground plate 2141. The ground sections 2121 can also be directly punched and formed by the ground structure 214. The ground sections 2121 can be formed by punching from one of the upper ground plate 2140 and the lower ground plate 2141, or they can be formed by the upper ground plate 2140 and the lower ground plate 2141.

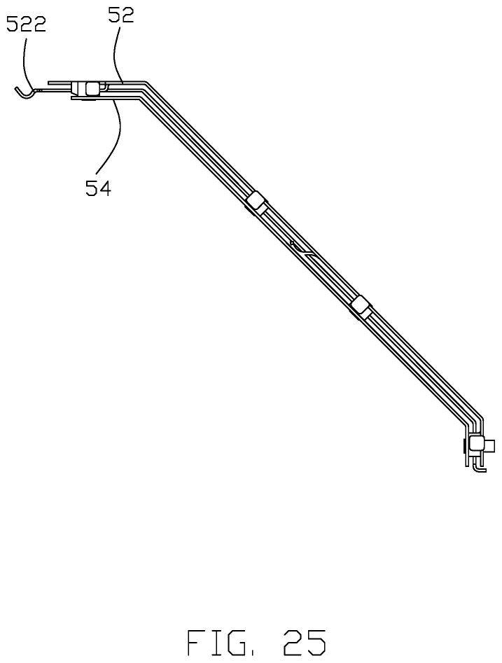

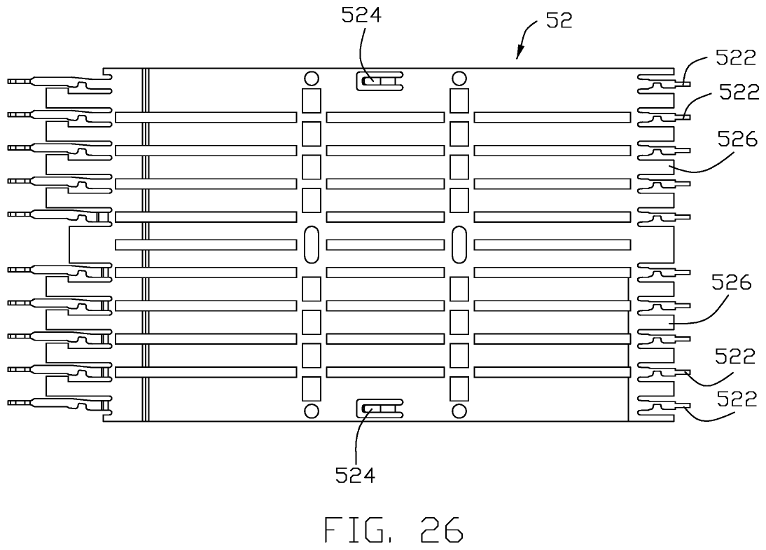

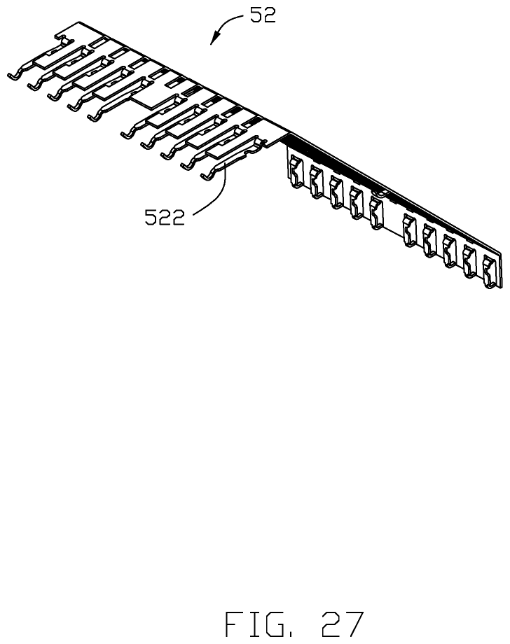

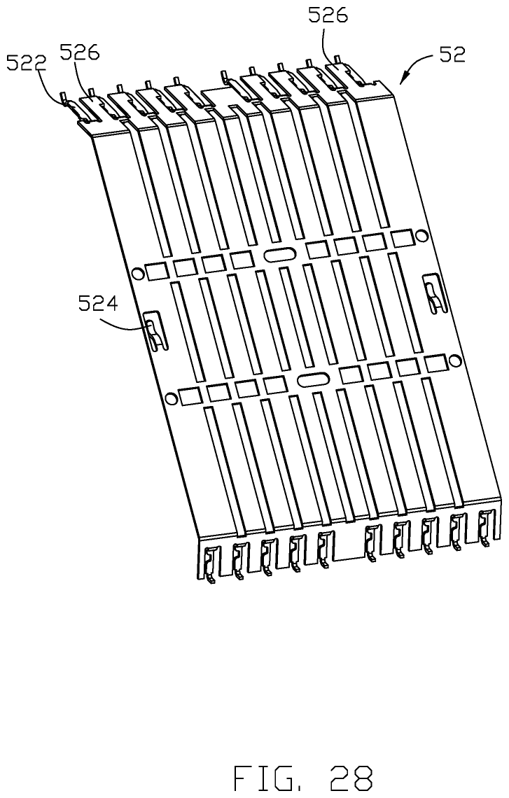

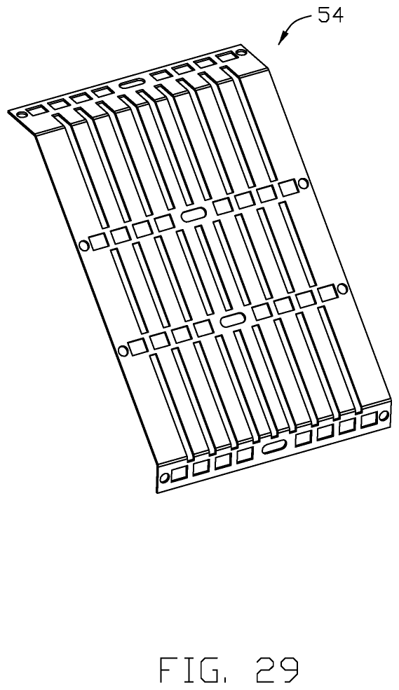

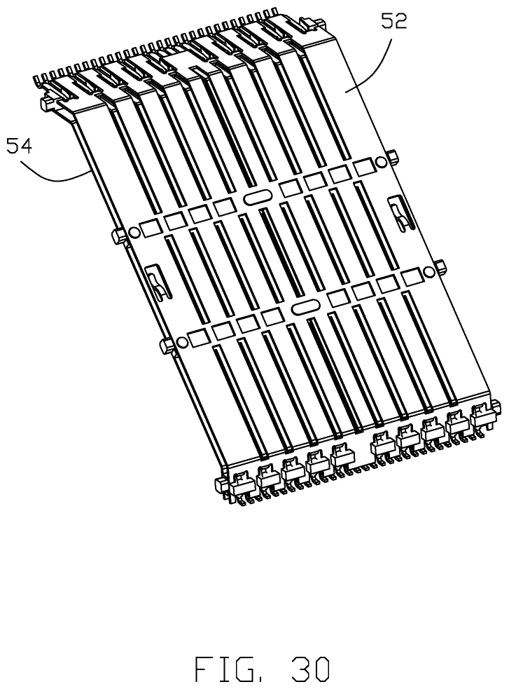

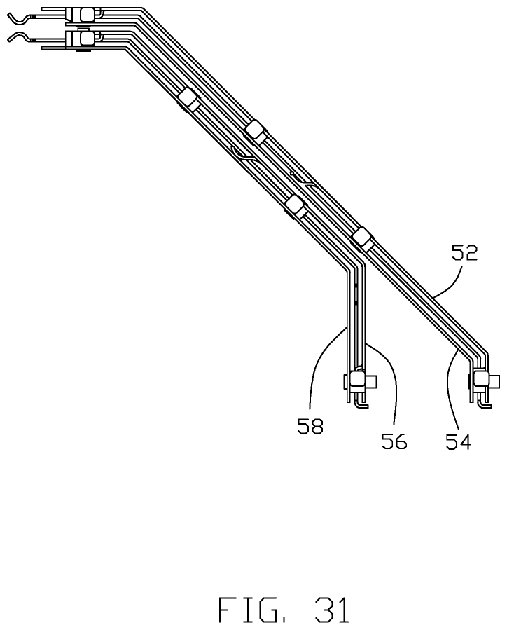

Referring now to FIGS. 25-31, in a varied design, an upper ground plate 52 may integrally form a plurality of ground sections 522 constituting part of the plurality of contacting portions of the row of contacts. The ground sections 522 comprise a plurality of ground sections aligning with the contacting portions for differential pair signals, and a plurality of ground sections aligning with the mounting portions for differential pair signals. each of the upper ground plate 52 and the lower upper ground plate 54 are spaced apart from the intermediate portions, and are spaced apart at an equal distance, upper ground plate 52 and the lower upper ground plate 54 are not adjacent to the signal pins in the long intermediate portions, this will greatly reduce resonance as a critical SI function. As can be understood, the plurality of ground sections 522 may equally well be formed on a lower ground plate 54, or the upper ground plate 52 may form some of the plurality of ground sections 522 while the lower ground plate 54 forms the remaining ground sections. In another embodiment, all the ground sections aligning with the contacting portions are formed on one of the upper ground plate and the lower ground plate, and all the ground sections aligning with the mounting portions are formed on the other. In a similar manner, an upper ground plate 56 and a lower ground plate 58 of a lower assembly may include integral ground sections. Also the ground structure of a lower unit may be similarly constructed. The upper ground plate 52 may include one or more fingers 524 for touching the lower plate 54. The upper ground plate 52 may further include an overhanging feature for impedance control, such as front extensions 526 each situated between every two ground sections 522.

The insulator 213 extends transversely and has two opposite positioning ends 2130 for engaging with corresponding mounting holes 2300 of the pair of side plates 230. If desired, the positioning ends 2130 may be heat staked after securement in the mounting holes 2300. The insulator 213 preferably includes two or more separate pieces, in this embodiment, the number of insulator 213 is six. The number of the insulator 213 can be increased or decreased according to specific needs. Part of the insulator 213 only holds the intermediate portions 215 and the intermediate portions 217. The conductive element 216 provided on the insulators 213 electrically connect the upper ground plate 2140 and the lower ground plate 2141 together.

The structure of the lower assembly 220 is similar to the structure of the upper assembly 210. The main difference is that the size is relatively short, thus the number of insulator is also relatively less, The orientation of the contacting portions 2200 is opposite.

The overall length of the lower unit 22 is much smaller than the length of the upper unit 21, it can adopt a similar structure to the upper unit 21.

1. A contact assembly for an electrical connector, comprising:
a row of contacts having a plurality of contacting portions and a plurality of mounting portions;
an insulator secured to the plurality of contacting portions and the plurality of mounting portions;
an upper ground plate and a lower ground plate surrounding the row of contacts; and
a conductive element electrically connecting the upper and lower ground plates and selected ones of the row of contacts.

2. The contact assembly as claimed in claim 1, wherein the plurality of contacting portions comprise contacting sections for differential pair signals and contacting sections for grounds, the plurality of mounting portions comprise mounting sections for differential pair signals and mounting sections for grounds, and the row of contacts comprises an intermediate portion connecting the contacting section and the mounting section for differential pair signals.

3. The contact assembly as claimed in claim 2, wherein the contacting sections and the mounting sections for grounds are electrically connected by at least one of the upper ground plate and the lower ground plate.

4. The contact assembly as claimed in claim 2, wherein the plurality of contacting portions comprise side-band sections for control, power, and low-speed signals.

5. The contact assembly as claimed in claim 1, wherein the upper ground plate is disposed on one side of the row of contacts and spaced a first distance away from the row of contacts, and the lower ground plate is disposed on the other side of the row of contacts and spaced a second distance away from the row of contacts.

6. The contact assembly as claimed in claim 5, wherein the first distance is equal to the second distance.

7. The contact assembly as claimed in claim 1, wherein the upper ground plate and the lower ground plate span a width beyond the outermost contacting portions and the outermost mounting portions.

8. The contact assembly as claimed in claim 1, wherein the conductive element is separately made from metal or mixed materials and then mounted to the insulator.

9. The contact assembly as claimed in claim 1, wherein the conductive element is formed in situ from conductive plastic material having a surface resistivity of about 0.1 Ω/square or having a bulk resistivity of about 0.01 Ω-cm.

10. The contact assembly as claimed in claim 1, wherein each of the upper and lower ground plates has plural openings for circulation of air.

11. The contact assembly as claimed in claim 1, wherein the insulator has plural protruding blocks and the upper and lower ground plates have mounting holes.

12. The contact assembly as claimed in claim 1, wherein the upper ground plate and the lower ground plate surround the intermediate portions of signal pair to form a strip-line structure.

13. A contact assembly for an electrical connector, comprising:
a row of contacts having a plurality of contacting portions and a plurality of mounting portions;
an insulator secured to the plurality of contacting portions and the plurality of mounting portions; and
an upper ground plate and a lower ground plate surrounding the row of contacts; wherein
at least one of the upper and lower ground plates integrally forms a plurality of ground sections constituting part of the plurality of contacting portions of the row of contacts.

14. The contact assembly as claimed in claim 13, wherein one of the upper and lower ground plates integrally forms one or more fingers in touch with the other ground plate.

15. The contact assembly as claimed in claim 13, further comprising a conductive element electrically connecting the upper and lower ground plates.

16. The contact assembly as claimed in claim 13, wherein the upper ground plate comprises an overhanging feature for impedance control.

17. The contact assembly as claimed in claim 13, wherein the overhanging feature comprises plural front extensions each situated between every two ground sections.

18. An electrical connector for mounting on a circuit board and mating with a mating connector, comprising a contact assembly which comprises:
a row of contacts having a plurality of contacting portions for differential pair signals and a plurality of mounting portions for differential pair signals;
an upper ground plate and a lower ground plate surrounding the row of contacts; wherein
at least one of the upper and lower ground plates integrally forms a plurality of ground sections aligning with the contacting portions for differential pair signals, and at least one of the upper and lower ground plates integrally forms a plurality of ground sections aligning with the mounting portions for differential pair signals.

19. The electrical connector as claimed in claim 18, wherein all the ground sections aligned with the contacting portions are formed on one of the upper ground plate and the lower ground plate, and all the ground sections aligned with the mounting portions are formed on the other of the upper ground plate and the lower ground plate.

20. The electrical connector as claimed in claim 18, further including an insulator secured to the plurality of contacting portions and the plurality of mounting portions.
